(19) United States
(12) Patent Application Publication
(10) Pub. No.: US 2024/0397357 A1
(43) Pub. Date: Nov. 28, 2024

(54) SERVICE CONTINUITY OF SIDELINK RELAY COMMUNICATION

(71) Applicant: ZTE CORPORATION, Shenzhen (CN)

(72) Inventors: Mengzhen WANG, Shenzhen (CN); Lin CHEN, Shenzhen (CN); Weiqiang DU, Shenzhen (CN); Wanfu XU, Shenzhen (CN)

(73) Assignee: ZTE CORPORATION, Shenzhen (CN)

(21) Appl. No.: 18/670,448

(22) Filed: May 21, 2024

Related U.S. Application Data
(63) Continuation of application No. PCT/CN2021/133651, filed on Nov. 26, 2021.

(51) Int. Cl. H04W 24/10; H04B 17/318; H04W 8/00; H04W 92/18

(52) U.S. Cl. CPC H04W 24/10; H04B 17/328; H04W 8/005; H04W 92/18

(57) ABSTRACT

A wireless communication method for use in a first wireless network node is disclosed. The method comprises receiving status information indicating at least one missing packet for which a successfully delivery has not been confirmed by a first device, wherein the first device connected to the first wireless network via a second device, and transmitting, to a second wireless network node, the at least one missing packet.

### CROSS-REFERENCE TO RELATED PATENT APPLICATIONS

This application is a Continuation of PCT Application No. PCT/CN2021/133651, filed Nov. 26, 2021, incorporated herein by reference in its entirety.

### TECHNICAL FIELD

This document is generally directed to wireless communications, including 5^{th} generation (5G) communications.

### BACKGROUND

With the development of wireless multimedia services, demands for high data rate and great user experience continuously increase, resulting in higher requirements of the system compacity and coverage of conventional cellular networks. On the other hand, demands for proximity services also increase because of application scenarios such as public security, social network, near-field data sharing and local advertisement. Traditionally, the cellular network using the base station as the center may have obvious limitations on supporting the high data rates and the proximity service. In order to satisfy such requirements, device-to-device (D2D) communication technology is proposed. By applying the D2D communication technology, burden of the cellular network can be relieved, power consumption of the user equipment (UE) can be reduced and the data rate can be increased and the robustness of the network infrastructure can be improved. Thus, the demands for high data rate and proximity services are greatly satisfied. In this context, D2D communication technology is also named proximity services (ProSe) or sidelink communications, wherein an interface between the UEs is called PC5 interface.

### SUMMARY

For supporting applications and services in a broader scope (e.g., indoor relay communication, smart agriculture, smart factory, public security, etc.), sidelink-based relay communications may be used to extend the coverage and improve the power consumption. For example, the sidelink-based communications may be applied in two application scenarios shown in FIG. 1:
1) UE-to-Network relay (Pattern 1): This type of relay is used for the UE in a weak/no coverage area. In FIG. 1, a UE1 in the weak/no coverage area is allowed to communicate with the network (e.g., base station) via a UE2 under a coverage of the network. The UE-to-Network relay may help the network operator to extend the coverage and increase the capacity of the network. Note that, in FIG. 1, the UE1 may be called remote UE and the UE2 may be called UE-to-Network relay.
2) UE-to-UE relay (Pattern 2): For an emergency scenario (e.g., earthquake) of the network working abnormally or for extending a sidelink communication range, the UEs may be allowed to communicate with each other via relay UE(s). For example, UE3 and UE4 in FIG. 1 communicate with each other via a UE5 or multiple relay UEs. The UE5 may be called UE-to-UE relay.

In long term evolution (LTE), two UE-to-Network replay technical solutions are provided, i.e., internet protocol (IP) based layer (Layer 3 (L3)) and access stratum layer (Layer 2 (L2)). Note that a Layer 3 relay forwards data based on the target IP address/port number and a Layer 2 relay performs route forwarding of the control plane and user plane data, so as to allow the network operator (i.e., core network (CN) network elements and base stations) to effectively manage remote devices (i.e., remote UEs). Because of significant differences between new radio (NR) sidelink communication and LTE sidelink communication (e.g., on frame structure, quality of service (QOS) processing, bearer configuration and establishment, etc.), LTE based sidelink relay technical solutions cannot be applied to the 5G/NR system. Thus, new technical solutions for the 5G/NR system are required.

For example, the UE may communicate with the network via the relay device when a signal quality between the UE and the network is inferior or the UE is outside of network coverage. When the UE moves into the network coverage or the signal quality between the UE and the network becomes better, the UE may change to direct communication with the network. How to ensure service continuity and reduce service interruption delay during the path switch between the relay communication link to the direct communication link becomes a topic to be discussed.

This document relates to methods, systems, and devices for the service continuity of the sidelink relay communications, and in particular to methods, systems, and devices for the service continuity during the path switch related to the sidelink relay communications.

The present disclosure relates to wireless communication method for use in a first wireless network node. The method comprises:
receiving status information indicating at least one missing packet for which a successfully delivery has not been confirmed by a first device, wherein the first device connected to the first wireless network via a second device, and transmitting, to a second wireless network node, the at least one missing packet.

Various embodiments may preferably implement the following features:

Preferably or in some embodiments, the status information is received from the second wireless network node.

Preferably or in some embodiments, the status information comprises a Packet Data Convergence Protocol status report of the first device for downlink packets.

Preferably or in some embodiments, the status information comprises at least one of a field indicating the first missing packet or a bitmap indicating the at least one missing packet and at least one packet received by the first device for downlink packets.

Preferably or in some embodiments, the status information is received from the second device.

Preferably or in some embodiments, the status information comprises at least one radio link control status of at least one downlink packet received by the first device.

Preferably or in some embodiments, the status information comprises at least one of at least one Packet Data Convergence Protocol sequence number of the at least one missing packet or at least one Packet Data Convergence Protocol sequence number of at least one packet for which a successful delivery has been confirmed by the first device.

Preferably or in some embodiments, the wireless communication method further comprises performing a path switch of handing over the first device to the second wireless network node or to a third device served by the second wireless network node.

The present disclosure relates to a wireless communication method for use in a second wireless network node. The method comprises:
transmitting, to a first wireless network node, status information indicating at least one missing packet for which a successful delivery has not been confirmed by a first device, wherein the first device connected to the first wireless network node via a second device, and receiving, from a first wireless network node, the at least one missing packet.

Various embodiments may preferably implement the following features:

Preferably or in some embodiments, the wireless communication method further comprises transmitting, to the first device, the at least one missing packet.

Preferably or in some embodiments, the status information comprises a Packet Data Convergence Protocol status report of the first device for downlink packets.

Preferably or in some embodiments, the status information comprises at least one of at least one Packet Data Convergence Protocol sequence number of the at least one missing packet or at least one Packet Data Convergence Protocol sequence number of at least one packet for which a successful delivery has been confirmed by the first device.

Preferably or in some embodiments, the wireless communication method further comprises receiving, from the first device, a Packet Data Convergence Protocol status report for downlink packets.

The present disclosure relates to a wireless communication method for use in a second device. The method comprises:
forwarding traffics between a first device and a first wireless network node, and
transmitting, to the first wireless network node, status information indicating at least one missing packet for which a successful delivery has not been confirmed by the first device.

Various embodiments may preferably implement the following features:

Preferably or in some embodiments, the status information comprises at least one radio link control status of at least one downlink packet received by the first device.

Preferably or in some embodiments, the status information comprises at least one of at least one Packet Data Convergence Protocol sequence number of the at least one missing packet or at least one Packet Data Convergence Protocol sequence number of at least one packet for which a successful delivery has been confirmed by the first device.

The present disclosure relates to a wireless communication method for use in a first wireless network node. The method comprises:
transmitting, to a second wireless network node, a handover request message of switching a first device to a second device served by the second wireless network node, and
receiving, from the second wireless network node, a handover request acknowledge message.

Various embodiments may preferably implement the following features:

Preferably or in some embodiments, the handover request message comprises at least one of a relay path switch indication, a layer 2 identifier of the first device, a layer 2 identifier of the second device or a cell radio network temporary identifier of the second device.

Preferably or in some embodiments, the handover request acknowledge message comprises at least one of a cell radio network temporary identifier assigned by the second wireless network node for the first device, a local identifier assigned by the second wireless network node for the first device, a PC5 radio link control configuration for relaying traffics or the end-to-end radio bearer configuration for the first device.

Preferably or in some embodiments, the second device is selected from at least one candidate second device reported by the first device, wherein the method further comprises transmitting, to the first device, at least one criterion for reporting the at least one candidate second device, and the at least one criterion comprises at least one of a black-list of candidate second devices, a white-list of candidate second devices, a black-list of candidate cell identifiers serving candidate second devices, a white-list of candidate cell identifiers serving candidate second devices, a maximum number of the candidate second devices reported by the first device or a priority for each sidelink measurement report event for reporting the candidate second device.

The present disclosure relates to a wireless communication method for use in a second wireless network node. The method comprises:
receiving, from a first wireless network node, a handover request message of switching a first device to a second device served by the second wireless network node, and
transmitting, to the first wireless network node, a handover request acknowledge message.

Various embodiments may preferably implement the following features:

Preferably or in some embodiments, the handover request comprises at least one of a relay path switch indication, a layer 2 identifier of the first device, a layer 2 identifier of the second device or a cell radio network temporary identifier of the second device or the end-to-end radio bearer configuration for the first device.

Preferably or in some embodiments, the handover request acknowledge comprises at least one of a cell radio network temporary identifier assigned by the second wireless network node for the first device, a local identifier assigned by the second wireless network node for the first device, a PC5 radio link control configuration for relaying the traffics.

The present disclosure relates to a wireless communication method for use in a wireless network node. The method comprises transmitting, to a first device, a sidelink measurement configuration comprising at least one sidelink measurement event associated with triggering a sidelink measurement report.

Various embodiments may preferably implement the following features:

Preferably or in some embodiments, the first device connects to the wireless network node via a second device.

Preferably or in some embodiments, the at least one sidelink measurement event comprises at least one of: a quality of a serving relay link between the first device and the second device is lower than a first threshold, a quality of a candidate relay link between the first device and a candidate device is greater than a second threshold, a quality of a serving relay link between the first device and the second device is lower than a third threshold and a quality of a candidate relay link between the first device and a candidate device is greater than a fourth threshold, a quality of a serving relay link between the first device and the second device is lower than a quality of a candidate relay link between the first device and a candidate device, or a quality of a serving relay link between the first device and the second device is lower than a quality of a candidate relay link between the first device and a candidate device by an offset.

Preferably or in some embodiments, the quality is a sidelink reference signal received power or a sidelink discovery reference signal received power.

The present disclosure relates to a wireless communication method for use in a first device. The method comprises receiving, from a wireless network node, a sidelink measurement configuration comprising at least one sidelink measurement event associated with triggering a sidelink measurement report.

Various embodiments may preferably implement the following features:

Preferably or in some embodiments, the first device connects to the wireless network node via a second device.

Preferably or in some embodiments, the at least one sidelink measurement event comprises at least one of: a quality of a serving relay link between the first device and the second device is lower than a first threshold, a quality of a candidate relay link between the first device and a candidate device is greater than a second threshold, a quality of a serving relay link between the first device and the second device is lower than a third threshold and a quality of a candidate relay link between the first device and a candidate device is greater than a fourth threshold, a quality of a serving relay link between the first device and the second device is lower than a quality of a candidate relay link between the first device and a candidate device, or a quality of a serving relay link between the first device and the second device is lower than a quality of a candidate relay link between the first device and a candidate device by an offset.

Preferably or in some embodiments, the quality is a sidelink reference signal received power or a sidelink discovery reference signal received power.

The present disclosure relates to a wireless communication method of a wireless network node. The method comprises initiating a paging procedure associated with paging a second device to turn into a radio resource control, RRC, connected state for relaying traffics of a first device.

Various embodiments may preferably implement the following features:

Preferably or in some embodiments, the second device is in an RRC inactive state, and the paging procedure comprises transmitting, to at least one neighbor wireless network node, a paging message comprising at least one of an indication of relaying traffics or a layer 2 identifier of the second device.

Preferably or in some embodiments, the second device is in an RRC inactive state and the paging procedure comprises transmitting, to a last wireless network node serving the second device, a request message for paging the second device, wherein the request message comprises at least one of an indication of relaying traffics or a layer 2 identifier of the second device.

Preferably or in some embodiments, the second device is in an RRC idle state and the paging procedure comprises transmitting, to an access and mobility management function, a request message for paging the second device, wherein the request message comprises at least one of an indication of relaying traffics, a layer 2 identifier of the second device or a serving temporary mobile subscriber identifier of the second device.

Preferably or in some embodiments, the wireless communication method further comprises receiving, from the access and mobility management function, a paging message associated with paging the second device, wherein the paging message comprises at least one of the layer 2 identifier of the second device, the serving temporary mobile subscriber identifier of the second device, or the indication of relaying traffics.

The present disclosure relates to a wireless communication method for use in an access and mobility management function. The method comprises:
receiving, from a wireless network node, a request message for paging a second device to turn into a radio resource control, RRC, connected state for relaying traffics of a first device, and
transmitting, to the wireless network node, a paging message associated with paging the second device,
wherein the request message comprises at least one of an indication of relaying traffics, a layer 2 identifier of the second device or a serving temporary mobile subscriber identifier of the second device

Various embodiments may preferably implement the following feature:

Preferably or in some embodiments, the paging message comprises at least one of the layer 2 identifier of the second device, the serving temporary mobile subscriber identifier of the second device, or the indication of relaying traffics.

The present disclosure relates to a first wireless network node. The first wireless network node comprises a communication unit configured to:
receive status information indicating at least one missing packet for which a successfully delivery has not been confirmed by a first device, wherein the first device connected to the first wireless network via a second device, and
transmit, to a second wireless network node, the at least one missing packet.

Various embodiments may preferably implement the following feature:

Preferably or in some embodiments, the first wireless network node further comprises a processor configured to perform any of aforementioned wireless communication methods.

The present disclosure relates to a second wireless network node. The second wireless network node comprises a communication unit configured to:
transmit, to a first wireless network node, status information indicating at least one missing packet for which a successful delivery has not been confirmed by a first device, wherein the first device connected to the first wireless network node via a second device, and
receive, from a first wireless network node, the at least one missing packet.

Various embodiments may preferably implement the following feature:

Preferably or in some embodiments, the second wireless network node further comprises a processor configured to perform any of aforementioned wireless communication methods.

The present disclosure relates to a second device. The second device comprises a communication unit configured to:
forward traffics between a first device and a first wireless network node, and
transmit, to the first wireless network node, status information indicating at least one missing packet for which a successful delivery has not been confirmed by the first device.

Various embodiments may preferably implement the following feature:

Preferably or in some embodiments, the second device further comprises a processor configured to perform any of aforementioned wireless communication methods.

The present disclosure relates to a first wireless network node. The first wireless network node comprises a communication unit configured to:
transmit, to a second wireless network node, a handover request message of switching a first device to a second device served by the second wireless network node, and
receive, from the second wireless network node, a handover request acknowledge message

Various embodiments may preferably implement the following feature:

Preferably or in some embodiments, the first wireless network node further comprises a processor configured to perform any of aforementioned wireless communication methods.

The present disclosure relates to a second wireless network node. The second wireless network node comprises a communication unit configured to:
receive, from a first wireless network node, a handover request message of switching a first device to a second device served by the second wireless network node, and
transmit, to the first wireless network node, a handover request acknowledge message.

Various embodiments may preferably implement the following feature:

Preferably or in some embodiments, the second wireless network node further comprises a processor configured to perform any of aforementioned wireless communication methods.

The present disclosure relates to a wireless network node. The wireless network node comprises a communication unit, configured to transmit, to a first device, a sidelink measurement configuration comprising at least one sidelink measurement event associated with triggering a sidelink measurement report, wherein the first device connects to the wireless network node via a second device.

Various embodiments may preferably implement the following feature:

Preferably or in some embodiments, the wireless network node further comprises a processor configured to perform any of aforementioned wireless communication methods.

The present disclosure relates to a first device. The first device comprises a communication unit configured to receive, from a wireless network node, a sidelink measurement configuration comprising at least one sidelink measurement event associated with triggering a sidelink measurement report, wherein the first device connects to the wireless network node via a second device.

Various embodiments may preferably implement the following feature:

Preferably or in some embodiments, the first device further comprises a processor configured to perform any of aforementioned wireless communication methods.

The present disclosure relates to a wireless network node. The wireless network node comprises:
a communication unit, and
a processor, configured to initiate a paging procedure associated with paging a second device to turn into a radio resource control, RRC, connected state for relaying traffics of a first device.

Various embodiments may preferably implement the following feature:

Preferably or in some embodiments, the processor is further configured to perform any of aforementioned wireless communication methods.

The present disclosure relates to a wireless device. The wireless device comprises a communication unit configured to:
receive, from a wireless network node, a request message for paging a second device to turn into a radio resource control, RRC, connected state for relaying traffics of a first device, and
transmit, to the wireless network node, a paging message associated with paging the second device,
wherein the request message comprising at least one of an indication of relaying traffics, a layer 2 identifier of the second device or a serving temporary mobile subscriber identifier of the second device.

Various embodiments may preferably implement the following feature:

Preferably or in some embodiments, the wireless device further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of scenarios of sidelink relay communication.

FIG. 2 shows a schematic diagram of a network according to an embodiment of the present disclosure.

FIG. 3 shows a schematic diagram of a signaling procedure of the remote UE inter-gNB RRC re-establishment according to an embodiment of the present disclosure.

FIG. 4 shows a schematic diagram of packet transmission during the RRC re-establishment according to an embodiment of the present disclosure.

FIG. 5 shows a schematic diagram of a path switch procedure according to an embodiment of the present disclosure.

FIG. 6 shows a schematic diagram of a path switch procedure according to an embodiment of the present disclosure.

FIG. 7 shows a schematic diagram of a path switch procedure according to an embodiment of the present disclosure.

FIG. 8 shows an example of a schematic diagram of a wireless terminal according to an embodiment of the present disclosure.

FIG. 9 shows an example of a schematic diagram of a wireless network node according to an embodiment of the present disclosure.

FIG. 10 shows a flowchart of a method according to an embodiment of the present disclosure.

FIG. 11 shows a flowchart of a method according to an embodiment of the present disclosure.

FIG. 12 shows a flowchart of a method according to an embodiment of the present disclosure.

FIG. 13 shows a flowchart of a method according to an embodiment of the present disclosure.

FIG. 14 shows a flowchart of a method according to an embodiment of the present disclosure.

FIG. 15 shows a flowchart of a method according to an embodiment of the present disclosure.

FIG. 16 shows a flowchart of a method according to an embodiment of the present disclosure.

FIG. 17 shows a flowchart of a method according to an embodiment of the present disclosure.

FIG. 18 shows a flowchart of a method according to an embodiment of the present disclosure.

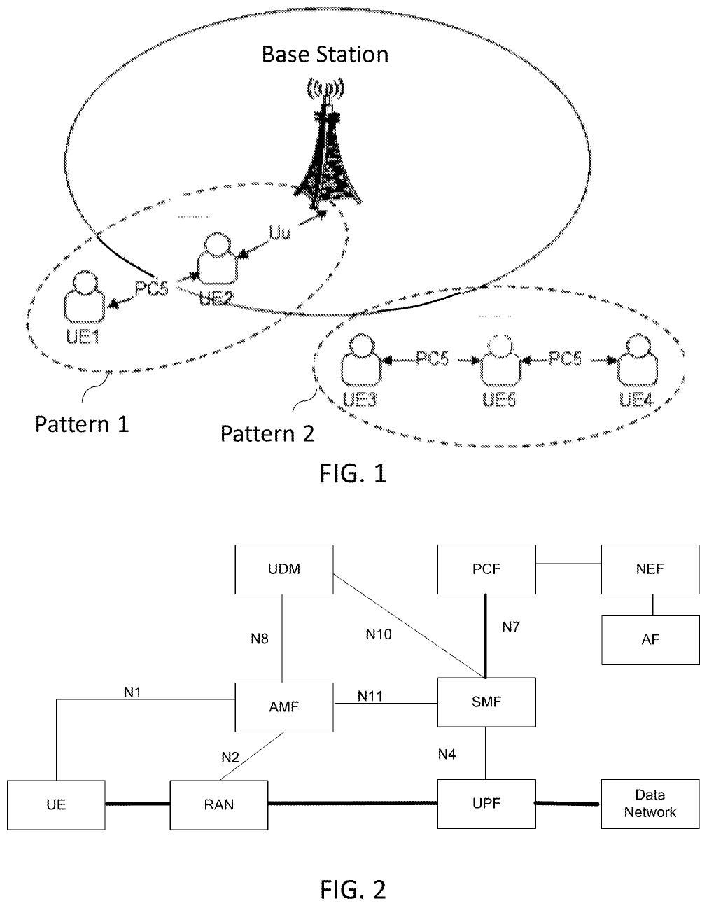

### DETAILED DESCRIPTION

FIG. 2 shows a schematic diagram of a network (architecture) according to an embodiment of the present disclosure. In FIG. 2, the network comprises the following network functions/entities:
1) UE: User Equipment
2) RAN: Radio Access Network

In the present disclosure, the RAN may be equal to a RAN node or a next-generation RAN (NG-RAN) (node).
3) AMF: Access and Mobility Management Function

The AMF includes the following functionalities: Registration Management, Connection Management, Reachability Management and Mobility Management. The AMF terminates the RAN Control Plane (CP) interface N2 and NAS interface N1, non-access stratum (NAS) ciphering and integrity protection. It also distributes the session management (SM) NAS to proper session management functions (SMFs) via interface N11. The AMF provides services for other consumer Network Functions (NFs) to subscribe or get notified of the mobility related events and information.
4) SMF: Session Management Function

The SMF includes the following functionalities: session establishment, modification and release, UE IP address allocation & management (including optional authorization functions), selection and control of the User Plane (UP) function, downlink data notification. The SMF can subscribe the mobility related events and information from the AMF.
5) UPF: User Plane Function

The UPF includes the following functionalities: serving as an anchor point for intra-/inter-radio access technology (RAT) mobility and the external session point of interconnect to Data Network, packet routing & forwarding as indicated by SMF, traffic usage reporting, quality of service (QOS) handling for the UP, downlink packet buffering and downlink data notification triggering, etc.
6) UDM: Unified Data Management

The UDM manages the subscription profile for the UEs. The subscription includes the data used for mobility management (e.g., restricted area), session management (e.g., QoS profile per slice per DNN). The subscription data also includes the slice selection parameters which are used for the AMF to select a proper SMF. The AMF and the SMF get the subscription from UDM. The subscription data is stored in the Unified Data Repository (UDR). The UDM uses such data upon reception of a request from the AMF or the SMF.
7) PCF: Policy Control Function

The PCF supports unified policy framework to govern network behavior. The PCF provides an access management policy to the AMF, or a session management policy to the SMF, and/or a UE policy to the UE. The PCF can access the UDR to obtain subscription information relevant for policy decisions. The PCF may also generate the policy to govern network behavior based on the subscription and an indication from an application function (AF). Then, the PCF can provide policy rules to CP functions (e.g., the AMF and/or the SMF) to enforce the CP functions.
8) NEF: Network Exposure Function

The NEF supports exposure of capability and events of the network towards the AF. A third party AF can invoke the service provided by the network via the NEF and the NEF performs authentication and authorization of the third party applications. The NEF also provides a translation of the information exchanged with the AF and information exchanged with the internal NF.
9) AF: Application Function

The AF interacts with the Core Network in order to provide services, e.g., to support: application influence on traffic routing, accessing the NEF, interacting with the Policy framework for policy control etc. The AF may be considered to be trusted by the operator can be allowed to interact directly with relevant NFs. The AF not allowed by the operator to access directly the NFs shall use the external exposure framework via the NEF to interact with relevant NFs. The AF may store the application information in the UDR via the NEF.

In an embodiment of a remote UE performing a radio resource control (RRC) re-establishment to a gNB, the inter-gNB RRC re-establishment for L2 UE-to-Network remote UE needs to be considered. For example, the remote UE connects to an original gNB via a relay UE. The relay UE forwards UL/DL data between the remote UE and the gNB. After a while, if the remote UE detects a PC5 radio link failure (RLF) with the relay UE, the remote UE may initiate an RRC re-establishment procedure and a neighbor cell belonging to another gNB (different from the serving gNB of the relay UE (i.e., the original gNB)) may be selected to perform the RRC re-establishment.

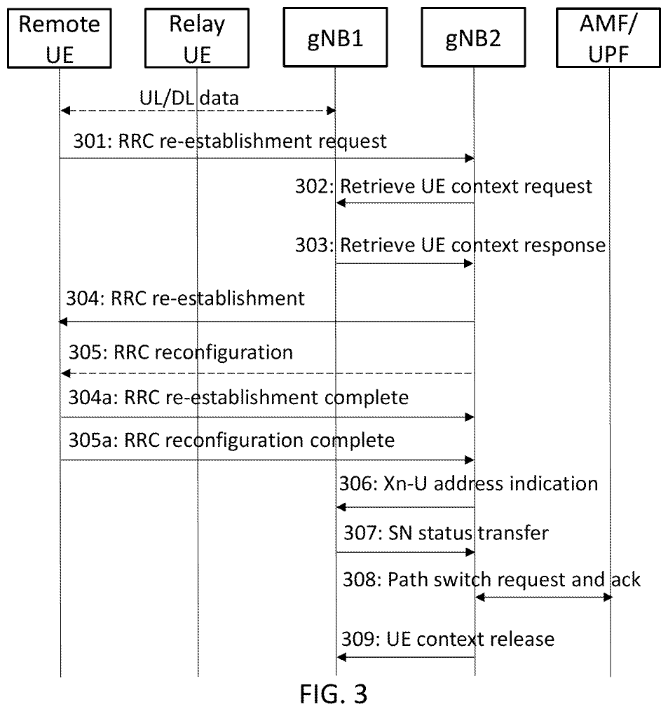

FIG. 3 shows a schematic diagram of a signaling procedure of the remote UE inter-gNB RRC re-establishment according to an embodiment of the present disclosure. During the RRC re-establishment, a Sequence Number (SN) status transfer (step 306/307) and a path switch (step 308) are performed to ensure service continuity. In this embodiment, lossless delivery of DL data transfer during the RRC re-establishment is discussed.

In an embodiment of the UE being directly connected to an original gNB (e.g., source gNB) and initiating the RRC re-establishment, the original gNB sends an SN status transfer to a new gNB (e.g., target gNB), wherein a downlink (DL) status transfer is a DL count value. The DL count value indicates a PDCP SN and a Hyper Frame Number that the new gNB should assign for the next DL service data unit (SDU) not having an SN yet. At the same time, data forwarding should take place as long as packets are received at the source gNB from the UPF or the source gNB buffer has not been emptied. Specifically, the source gNB sends the PDCP PDUs that has been sent to the UE but has not received successful delivery confirmation from the UE, the PDCP PDUs that has been cached in the source gNB but has not been sent to the UE (i.c., PDCP SN has been allocated), and the PDCP SDUs that has not been allocated with the PDCP SN to the target gNB. The target gNB retransmits and preferentially transmits all DL data forwarded by the source gNB to the UE. The PDCP SDUs with the PDCP SN are transmitted and the PDCP SDUs without the SN are subsequently transmitted. The PDCP SDUs which are confirmed as having been received based on the PDCP status report received from the UE need not be retransmitted.

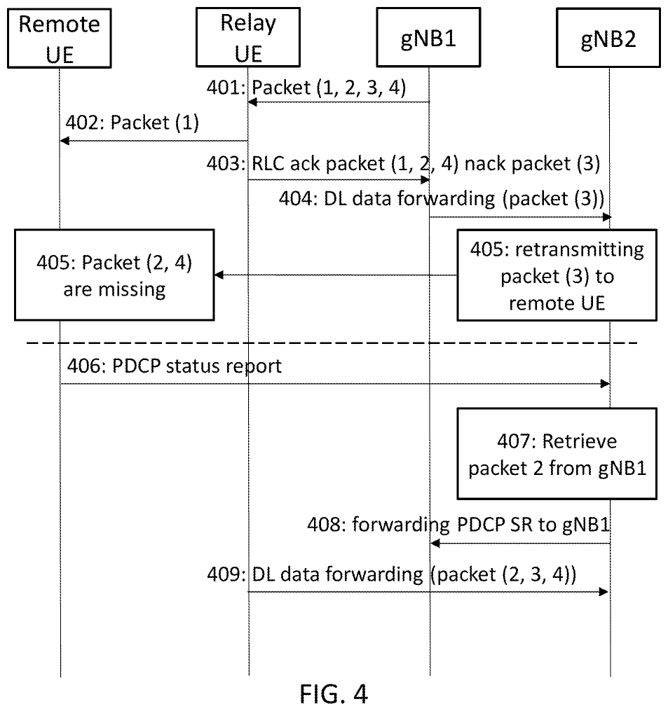

When it comes to a UE-to-Network relay scenario (e.g. FIG. 3), if the remote UE initiates an RRC re-establishment towards a target gNB (e.g. gNB2 shown in FIG. 3) which is different from the gNB serving the relay UE (i.e. source gNB, gNB1 shown in FIG. 3), the source gNB may only forward the PDCP PDU which has not been acknowledged by the relay UE instead of the remote UE. Under such a condition, a packet loss may occur. For example, in FIG. 4, the remote UE originally connects to the gNB1 via the relay UE. In DL data transmissions, the gNB1 transmits packets (1,2,3,4) of the remote UE to the relay UE and the relay UE forwards the received packets to the remote UE. The gNB1 may receive a radio link control (RLC) acknowledge (ack) of the packets (1,2,4) and non-acknowledge (nack) of the packet 3, from the relay UE. The gNB1 forwards the packet 3 which is not acknowledged and/or successfully confirmed by the relay UE to the gNB2 and the gNB2 retransmits the packet 3 directly to the remote UE. However, if a PC5 RLF happens after the relay UE transmits the packet 1 to the remote UE while the packets 2 and 4 are still cached in the buffer of the relay UE, the packets 2 and 4 supposed to be transmitted to the remote UE are lost (steps 401 to 405).

To ensure lossless delivery during a remote UE RRC re-establishment procedure (e.g., FIG. 3), the source gNB needs to know the receiving status of the remote UE and forwards the packets that are not received by the remote UE to the target gNB.

In an embodiment, the target gNB may forward the PDCP status for DL data packets of the remote UE to the source gNB after receiving a PDCP status report for DL data packets from the remote UE. Based on the PDCP status, the source gNB forwards the DL PDCP PDU(s) that has been (acknowledged by relay UE but) not confirmed by the remote UE to the target gNB and the target gNB forwards the received packet(s) to the remote UE.

In the embodiment shown in FIG. 4, when or after the remote UE completes the RRC re-establishment and sends an RRC re-establishment complete message to the target gNB2, the remote UE sends the PDCP status report for DL data packets (e.g., indicating the ack of packet 1 and/or the first missing packet 2) to the target gNB2 (as configured by the target gNB2). The target gNB2 sends the PDCP status for DL data packets of the remote UE to the source gNB1 according to the received PDCP status report for DL data packets. In an embodiment, the target gNB2 directly forwards the PDCP status report received from the remote UE to the source gNB1, e.g., via an Xn-U address indication message, other existing Xn messages or new Xn message transmitted from the target gNB2 to the source gNB1. The source gNB1 sends the uplink (UL)/DL PDCP SN and hyper frame number (HFN) status in the SN status transfer to the target gNB2. As an alternative, the target gNB2 may include the First Missing COUNT (e.g., packet 2) and/or a Bitmap associated with the PDCP status of the remote UE, e.g., in (a PDCP status transfer DL of) an Xn-U address indication message, other existing Xn messages or new Xn message sending to the source gNB1. Note that the bitmap may indicate which SDUs are missing and/or which SDUs are correctly received in the receiving PDCP entity of the remote UE. Based on the PDCP status of the remote UE, the source gNB1 forwards the DL PDCP PDU/SDU that has not been confirmed by the remote UE (e.g., packet (2,3,4)) to the target gNB2. In this embodiment, the packets 2 and 4, which are acknowledged by the relay UE but not acknowledged/confirmed by the remote UE, are transmitted to the target gNB2. The target gNB2 retransmits all packets forwarded by the source gNB1 to the remote UE, e.g., in a direct Uu link. As a result, the lossless delivery can be ensured. (Steps 406 to 409)

As an alternative or in addition, the relay UE may inform the source gNB1 which packets are successfully (or unsuccessfully) received by the remote UE. Based on the received information, the source gNB1 forwards all the packets that has not been successfully received by remote UE to the target gNB2. Specifically, the relay UE may send a Uu RLC status report (e.g., Uu RLC ack/nack) to the source gNB1 for a particular packet after receiving a PC5 RLC status report (e.g., PC5 RLC ack/nack) from the remote UE for this packet. For example, the relay UE may send an RLC ack of the packet 1 to the source gNB1 after receiving an RLC ack of the packet 1 from the remote UE. As an alternative or in addition, the relay UE may send an RLC nack of the packet 2 to the source gNB if receiving an RLC nack of the packet 2 from the remote UE. The relay UE may send an RLC nack of the packet 3 if receiving no feedback from the remote UE at an expiry of an associated timer (i.e., the packet 3 being lost is implicitly indicated). In this embodiment, the relay UE may record/recognize a mapping relationship between Uu RLC SN(s) and PC5 RLC SN(s) of the packets. As an alternative, the relay UE may send the PDCP SNs of packets which have been received/confirmed or not received/confirmed by the remote UE to the source gNB1. In this embodiment, the relay UE may identify the PDCP SN of the packet while there is no PDCP layer on the relay UE.

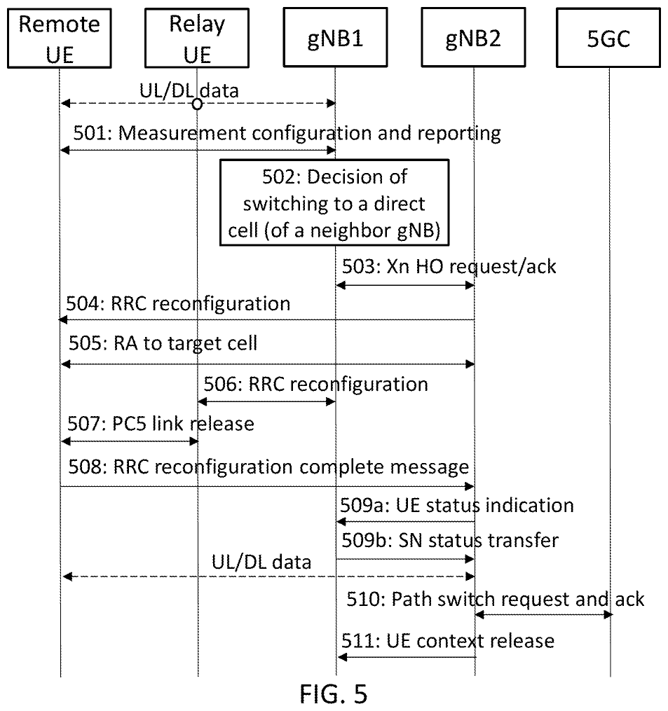

FIG. 5 shows a schematic diagram of a path switch procedure according to an embodiment of the present disclosure. In this embodiment, the service continuity for an L2 UE-to-Network remote UE path switch from an indirect link to a direct link is considered, in which the new serving gNB2 of the remote UE is different from a serving gNB1 of the relay UE. If the (remote) UE connects to the network via a U2N relay UE, the link between the UE and the network is called an indirect link. In comparison, a direct link refers to a link between the network and the (remote) UE connecting to the network via a direct Uu interface. For example, in FIG. 5, the remote UE connects to the (source) gNB1 via the relay UE. The relay UE helps forwarding UL/DL data between the remote UE and the gNB1. After a while, if the remote UE detects the PC5 link quality is getting worse and sends measurement reports to the gNB1, the gNB1 may configure the remote UE to perform a path switch to an Uu cell belongs to another gNB (i.e., gNB2). In this embodiment, the service continuity during the path switch procedure needs to be considered.

To ensure the lossless delivery during the remote UE path switch from the indirect link to the direct link in the inter-gNB case (e.g., FIG. 5), the source gNB1 needs to know the receiving status of the remote UE and forwards the packets that are not received by the remote UE to the target gNB2.

In an embodiment, the target gNB2 may forward the PDCP status received from the remote UE to the source gNB1 after receiving the PDCP status report from the remote UE. The source gNB1 may forward the DL PDCP PDU that has been (acknowledged by relay UE but) not confirmed by the remote UE to the target gNB2 and the target gNB2 forwards the received packet(s) to the remote UE.

For example, when or after the remote UE completes a random access to the target gNB2, the remote UE sends the PDCP status report (e.g., indicating the ack of packet 1 and/or the first missing packet 2) to the target gNB2 (as configured by the target gNB2). The target gNB2 may send the PDCP status of the remote UE to the source gNB1. In an embodiment, the target gNB2 directly forwards the PDCP status report received from the remote UE to the source gNB, e.g., via existing Xn messages (e.g., Xn-U address indication, NG-RAN NODE CONFIGURATION UPDATE, HANDOVER REPORT, RESOURCE STATUS REQUEST) or a new Xn message (e.g., UE status indication, SN status request, etc.) transmitted from the target gNB2 to the source gNB1 (step 509a). As an alternative, the target gNB2 may include the First Missing COUNT (e.g., packet 2) and/or a Bitmap associated with the PDCP status of the remote UE, e.g., (in a PDCP status transfer DL) in the existing Xn messages or new Xn message sending to the source gNB1 (step 509a). Note that the bitmap may indicate which SDUs are missing and/or which SDUs are correctly received in the receiving PDCP entity of the remote UE. Based on the PDCP status of the remote UE, the source gNB forwards the DL PDCP PDU/SDU that has not been confirmed by the remote UE (e.g., packet (2,3,4)) to the target gNB (step 509b). In this embodiment, the packets 2 and 4, which are acknowledged by the relay UE but not acknowledged by the remote UE, are transmitted to the target gNB2. The target gNB2 retransmits all packets forwarded by the source gNB1 to the remote UE, e.g., in a direct Uu link. As a result, the lossless delivery can be ensured.

As an alternative or in addition, the relay UE may inform the source gNB1 which packets are successfully (or unsuccessfully) received by the remote UE. Based on the received information, the source gNB1 forwards all the packets that has not been successfully received by the remote UE to the target gNB2. Specifically, the relay UE may send a Uu RLC ack/nack to the source gNB1 for a particular packet after receiving a PC5 RLC ack/nack from the remote UE for the packet. In this embodiment, the relay UE may record/recognize a mapping relationship between Uu RLC SN(s) and PC5 RLC SN(s) of the packets. As an alternative, the relay UE may send the PDCP SNs of packets which have been received or not received by the remote UE to the source gNB1. In this embodiment, the relay UE may identify the PDCP SN of the packet while there is no PDCP layer on the relay UE.

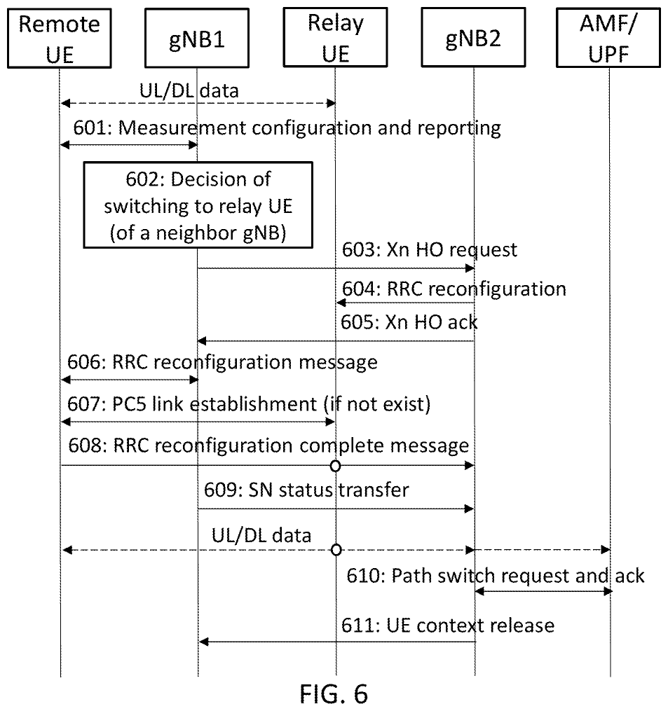

FIG. 6 shows a schematic diagram of a path switch procedure according to an embodiment of the present disclosure. In this embodiment, the service continuity for an L2 UE-to-Network remote UE path switch from the direct link to the indirect link is considered, wherein the new serving gNB of the relay UE (i.e., gNB2) is different from the original serving gNB of the remote UE (i.e., gNB1). For example, the remote UE is directly connected to the (source) gNB (i.e., gNB1). After a while, the remote UE may detect that the Uu link quality is getting worse and may send measurement reports to the source gNB1 and the source gNB1 may configure the remote UE to perform a path switch to the relay UE having another gNB as the serving gNB (i.e., gNB2). The relay UE helps forwarding UL/DL data between the remote UE and the gNB2.

In step 601, measurement configuration and measurement report signaling procedures are performed to evaluate both relay link measurements and Uu link measurements. The measurement results from the remote UE are reported when certain configured reporting criteria are met. The SL relay measurement report may include at least U2N Relay UE ID (e.g., L2 ID), serving cell ID, and sidelink discovery reference signal received power (SD-RSRP) or sidelink reference signal received power (SL-RSRP) information of one or multiple candidate relay UEs. The serving cell ID may be NCGI, NCI or PCI. The measurement report event may include at least one of:
1) Uu link quality of the serving Uu cell becomes worse than a threshold T1 and the PC5 link quality with a candidate relay UE is better/greater than a threshold T2;
2) the PC5 link quality with a candidate relay UE is better/greater than a threshold T3;
3) the PC5 link quality with a candidate relay UE is higher/greater than the Uu link quality of the serving Uu cell by an offset:
4) the Uu quality of a candidate relay UE is higher/greater than a threshold T4; or
5) the CBR of sidelink resource of a candidate relay UE is lower than a threshold T5.

In addition, some criteria may be configured to the remote UE for filtering the candidate relay UEs for the SL relay measurement reporting. In an embodiment, the criteria for filtering the candidate relay UEs may include at least one of:
1) a black-list/white-list of relay UE IDs (e.g., L2 ID): candidate relay UEs with UE IDs included in the black-list of relay UE IDs are not allowed/necessary to be reported, and candidate relay UEs with UE IDs included in the white-list are allowed to be reported.
2) a black-list/white-list of cell IDs (corresponding to serving cells of the relay UEs): i.e., a candidate relay UE with a serving cell ID included in the black-list of cell IDs is not allowed to be reported and a candidate relay UE with a serving cell ID included in a white-list of cell IDs is allowed to be reported.
3) the maximum number of candidate relay UEs; or
4) a priority or a weight for each measurement report event.

For example, the criteria for filtering the candidate relay UEs may comprise the maximum number of candidate relay UEs and the priority/weight for each measurement report event. In this example, if the number of candidate relay UEs is larger than the maximum number, the remote UE may report the candidate relay UEs fulfilling the measurement event with higher priority or weight. For instance, a priority/weight of the above measurement report event 2) may be higher than that of the above measurement report event 3). When the number of candidate relay UEs is larger than the maximum number, the UE may report the candidate relay UEs fulfilling the measurement event 2) (i.e., the candidate relay UE whose PC5 link quality is better than the threshold T3) and maybe some of the candidate relay UEs fulfilling the measurement event 3). That is at least one of the candidate relay UEs fulfilling the measurement event 3) is filtered out.

In step 602, the gNB1 decides to switch the remote UE to a target relay UE. The gNB1 identifies the serving gNB (i.e., gNB2) of the target relay UE based on the Serving cell ID of the relay UE in the SL measurement report from the remote UE.

In step 603, the gNB1 sends a handover request to the gNB2, to inform the path switch to the relay UE. For allowing the gNB2 to recognize the target relay UE, the handover request may include at least one of: relay path switch indication, L2 ID of the remote UE, L2 ID of the target relay UE, C-RNTI of the target relay UE.

In step 604, the gNB2 identifies the target relay UE and sends an RRC reconfiguration to the target relay UE, wherein the RRC reconfiguration may include at least one of the L2 ID of the remote UE, a local ID of the remote UE which is assigned by the gNB2, a local ID of the target relay UE which is assigned by the gNB2, a C-RNTI of the remote UE assigned by the gNB2, Uu RLC configuration for relaying, PC5 RLC configuration for relaying, bearer mapping configuration.

In step 605, the gNB2 sends a handover request acknowledge to the source gNB1, wherein the handover request acknowledge may include at least one of the remote UE's C-RNTI assigned by the gNB2, the local ID of the remote UE assigned by gNB2, the PC5 RLC configuration for relay traffic and the associated end-to-end radio bearer(s). In addition, a new timer may be configured by the gNB2 for the inter-gNB path switch. The timer is started when the remote UE receives the RRC reconfiguration including the timer. The remote UE may initiate an RRC re-establishment (towards a direct Uu cell or towards a relay UE) at the expiry of the timer. The stop condition of the timer may be one of the following:
1) successfully transmitting an RRC reconfiguration complete message to the relay UE (e.g., receiving RLC ack from the relay UE),
2) completing PC5 unicast link establishment with the relay UE,
3) receiving an RRCReconfigurationCompleteSidelink message from the relay UE,
4) receiving explicit successful indication (in a PC5 RRC message) from the relay UE after the relay UE successful transmitting/forwarding the RRC reconfiguration complete (of the remote UE) to the gNB2 (e.g., receiving RLC ack from gNB),
5) receiving successful indication (indicates the RRC reconfiguration complete message is successful received) from the gNB2 via an RRC message or a PDCP status report (e.g., a new indication bit) or a new PDCP control PDU.

In step 606, the gNB1 sends the RRCReconfiguration message to the remote UE including at least one of Relay UE ID, and the configuration information/handover command received from the gNB2. The remote UE stops UP and CP transmissions over Uu interface after receiving the RRCReconfiguration message from the gNB1.

In step 607, the remote UE establishes a PC5 unicast link with the target relay UE.

In step 608, the remote UE completes the path switch procedure by sending the RRCReconfigurationComplete message to the gNB2 via the relay UE.

In step 609, the source gNB1 sends an SN status transfer to the target gNB2 and delivers buffered data and new data from the UPF to the target gNB. Note that step 609 may be performed before step 607.

In steps 610 and 611, the gNB2 performs path switch with 5GC (5G core) (e.g., AMF/UPF) and triggers the source gNB1 to release UE context/resource.

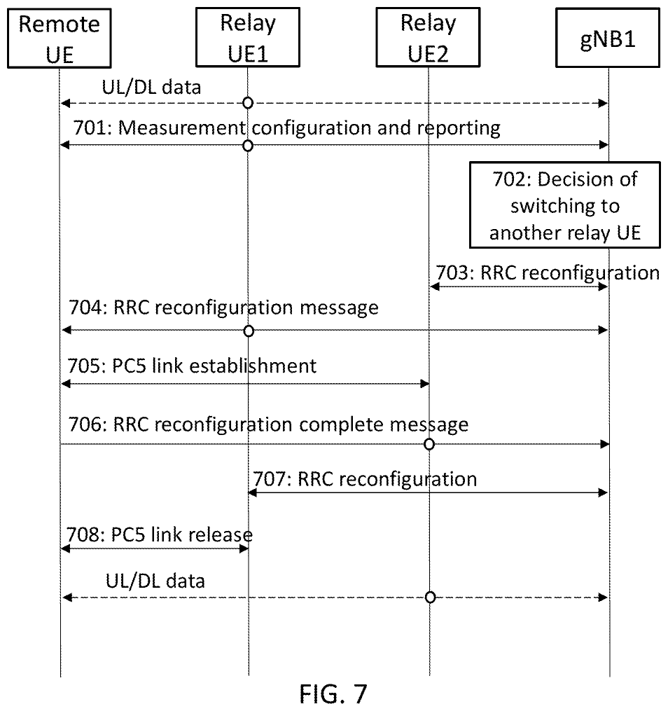

FIG. 7 shows a schematic diagram of a path switch procedure according to an embodiment of the present disclosure. In this embodiment, the L2 UE-to-Network remote UE path switch from indirect link to indirect link is considered. That is the remote UE perform a path switch from one relay link (connected to network via a relay UE) to another relay link. The path switch may comprise intra-gNB and inter-gNB cases. For example, in the intra-gNB case, the serving gNB of the new relay UE is the same with the serving gNB of the old relay UE. In the inter-gNB case, the serving gNB of the new relay UE is different from the serving gNB of the old relay UE. FIG. 7 shows the procedure of the path switch between indirect links for the intra-gNB case.

In step 701, the measurement configuration and measurement report signaling procedures are performed to evaluate both relay link measurement and Uu link measurement. The measurement results from the remote UE are reported when configured reporting criteria is met. The SL relay measurement report may include at least U2N Relay UE ID (e.g., L2 ID), serving cell ID, and SD-RSRP or SL-RSRP information of one or multiple candidate relay UEs. The gNB1 sends the SL Measurement report events and measurement quantity included in measurement configuration to the remote UE. In an embodiment, the SL measurement report events may include at least one of:
1) serving SL relay link SL-RSRP lower than a threshold TA,
2) serving SL relay link SD-RSRP lower than a threshold TB,
3) serving SL relay link quality lower than a threshold TC,
4) candidate/discovered SL relay link quality or SD-RSRP or SL-RSRP higher than a threshold TD,
5) serving SL relay link SL-RSRP/SD-RSRP/quality is lower than a threshold TE and a candidate SL relay link SD-RSRP/SL-RSRP/quality is higher than a threshold TF,
6) serving SL relay link SL-RSRP/SD-RSRP/quality is lower than a candidate SL relay link SD-RSRP/SL-RSRP/quality,
7) serving SL relay link SL-RSRP/SD-RSRP/quality is lower than a candidate SL relay link SD-RSRP/SL-RSRP/quality by an offset.

In addition, the gNB1 may indicate the remote UE that whether the SL-RSRP or the SD-RSRP is measured for the serving relay link. In the SL measurement report, the remote UE may indicate whether the measurement result is the SL-RSRP or the SD-RSRP for serving relay link and/or candidate relay links.

In steps 702 and 703, the gNB1 decides to switch the remote UE to a target relay UE (i.e., relay UE2). The gNB1 sends an RRCReconfiguration message to the relay UE2, wherein the message may include at least one of L2 ID of the remote UE, local ID assigned by the gNB1 for the remote UE, L2 ID of the old relay UE (i.e., relay UE1), Uu and PC5 RLC configuration for relaying, and bearer mapping configuration.

In step 704, the gNB1 sends the RRCReconfiguration message to the remote UE, wherein the message may include at least one of the local ID of the remote UE, ID of the new relay UE2, the PC5 RLC configuration for relay traffic and the associated end-to-end radio bearer(s). In addition, a new timer maybe configured for the path switch from one relay link to another relay link for the intra-gNB case. The stop condition of the timer may be one of the following:
1) successfully transmitting an RRC reconfiguration complete message to the relay UE (e.g., receiving RLC ack from the relay UE),
2) completing PC5 unicast link establishment with the relay UE,
3) receiving an RRCReconfigurationCompleteSidelink message from the relay UE,
4) receiving explicit successful indication (in a PC5 RRC message) from the relay UE after the relay UE successful transmitting/forwarding the RRC reconfiguration complete (of the remote UE) to the gNB2 (e.g., receiving RLC ack from gNB),
5) receiving successful indication (indicates the RRC reconfiguration complete message is successful received) from the gNB2 via an RRC message or a PDCP status report (e.g., a new indication bit) or a new PDCP control PDU.

The remote UE stops UP and CP transmissions over original relay link after receiving an RRCReconfiguration message from the gNB1.

In step 705, the remote UE establishes a PC5 connection with the new target relay UE2.

In step 706, the remote UE sends the RRCReconfigurationComplete message to the gNB1 via the new relay UE 2.

In step 707, the gNB1 sends an RRCReconfiguration message to the original relay UE1 to reconfigure the connection between the relay UE1 and the gNB1 (e.g., to release Uu and PC5 RLC configuration for relaying and bearer mapping configuration between the PC5 RLC and the Uu RLC). The RRCReconfiguration message to the Relay UE 1 can be sent any time after step 704.

In Step 708, either the relay UE1 or the remote UE initiates the PC5 unicast link release (PC5-S) after receiving the RRC reconfiguration message from the gNB1. The timing to execute link release is up to UE implementation.

For the path switch between indirect links of the inter-gNB case, the measurement configuration and reporting are the same as the step 701 for the intra-gNB case. The signaling exchange (e.g., path switch Information/configuration) between the source gNB (i.e., serving gNB of the source relay UE) and the target gNB (i.e., the serving gNB of the new target relay UE) and the RRC reconfiguration for the target relay UE by the target gNB are the same as the steps 603 to 605. In this case, the lossless delivery of DL data transfer can be achieved as the path switch from indirect-to-direct link for inter-gNB case shown in FIG. 5.

In an embodiment of the remote UE performing a path switch to an indirect link (e.g., path switch from a direct link to an indirect link for intra-/inter-gNB case, path switch from an indirect link to another indirect link for intra-/inter-gNB case), after receiving Uu and sidelink (SL) measurement report from remote UE, the gNB may prioritize to select a target relay UE in the RRC connected state. In an embodiment, if no such suitable relay UE (i.e., no candidate relay UE is in the RRC connected state), an RRC idle/inactive relay UE may be selected. The selected RRC idle/inactive relay UE needs to enter the RRC connected state for relaying traffic for the remote UE.

In an embodiment, if a relay UE in the RRC inactive state is selected as the target relay UE by the gNB, and if the gNB is the last serving gNB of the relay UE (the gNB stores the UE context of the relay UE), the gNB may initiate RAN paging. It means a new trigger for relay purpose/path switch of RAN paging is defined. In addition, the gNB may send XnAP RAN Paging to neighbor gNB(s) if the RAN configured to the relay UE includes cells of neighbor gNB(s). In the XnAP RAN paging message, an indication indicates relay purpose/path switch and/or relay UE L2 ID may be included.

In an embodiment, if a relay UE in the RRC inactive state is selected as the target relay UE by the gNB, and If the gNB is not the last serving gNB of the relay UE (gNB can recognize the last serving gNB of the relay UE according to the cell ID (e.g. NR cell ID (NCI) or NR cell global ID (NCGI)) in the measurement report from the remote UE), the gNB may send a request to the last serving gNB, to request the last serving gNB initiating the RAN paging for the relay UE. Specifically, the request message from the gNB to the last serving gNB may include at least one of an indication indicating relay purpose/path switch, or a relay UE L2 ID. In addition, the last serving gNB may send a response message to the gNB. In this case, the relay UE may be required to include its last serving gNB/cell ID (and optionally the current camped cell ID) in a discovery message. In addition, the remote UE may include the last serving gNB/cell ID of the relay UE in the SL measurement report.

In an embodiment, if a relay UE in RRC inactive state is selected as the target relay UE by the gNB, and If the gNB is not the last serving gNB of the relay UE, the gNB may retrieve the relay UE context from its last serving gNB and initiate RAN paging for the relay UE. In this case, a new trigger of relay purpose for an XnAP Retrieve UE Context procedure is required.

In an embodiment, if the selected target relay UE is in the RRC idle state, the gNB may send a request to the AMF, to request the AMF initiate a core network (CN) paging for the relay UE. Specifically, the request message may include at least one of an indication associated with the relay purpose/path switch, the relay UE L2 ID, the ng 5G-S-TMSI of the relay UE, the remote UE L2 ID, the ng 5G-S-TMSI of the remote UE, RAN remote UE NGAP ID. When receiving the request message, the AMF may initiate paging for the relay UE by including the relay UE L2 ID or the ng 5G-S-TMSI of the relay UE as the UE paging identity and optionally an indication associated with the relay purpose/path switch. In this case, it may require that the relay UE include its ng 5G-S-TMSI in a discovery message. In addition, the remote UE includes the ng 5G-S-TMSI of the relay UE in the SL measurement report.

In an embodiment, the RRC idle/inactive relay UE entering the RRC connected state may be triggered by a PC5 unicast establishment with the remote UE or an initial message from the remote UE. In the RRC reconfiguration message transmitted to the remote UE, UE-initiated or network-initiated may be configured to indicate that the UE initiated triggering or the network initiated triggering is applied to trigger the relay UE entering the RRC connected state. In addition, the remote UE may include the UE-initiated or the network-initiated in the PC5 unicast establishment message sending to the relay UE. After receiving the indication, the relay UE may decide to initiate an RRC setup procedure or wait for paging.

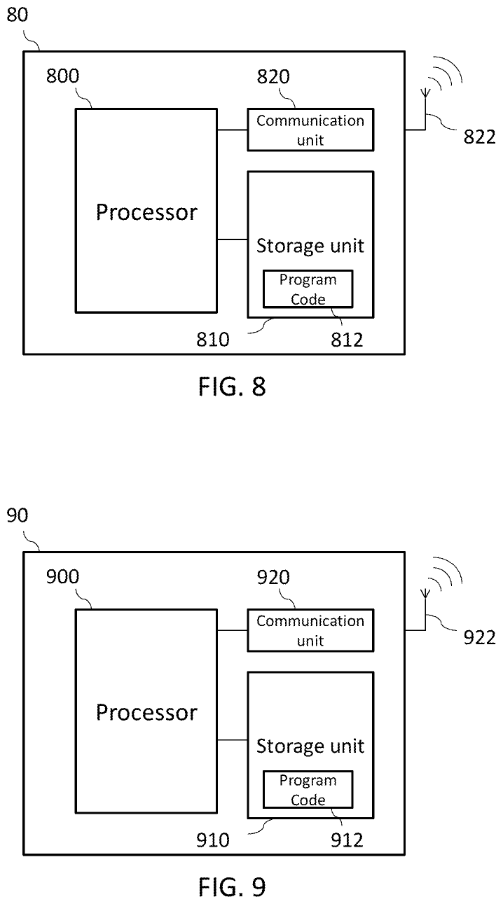

FIG. 8 relates to a schematic diagram of a wireless terminal 80 according to an embodiment of the present disclosure. The wireless terminal 80 may be a user equipment (UE), a mobile phone, a laptop, a tablet computer, an electronic book or a portable computer system and is not limited herein. The wireless terminal 80 may include a processor 800 such as a microprocessor or Application Specific Integrated Circuit (ASIC), a storage unit 810 and a communication unit 820. The storage unit 810 may be any data storage device that stores a program code 812, which is accessed and executed by the processor 800. Embodiments of the storage unit 812 include but are not limited to a subscriber identity module (SIM), read-only memory (ROM), flash memory, random-access memory (RAM), hard-disk, and optical data storage device. The communication unit 820 may a transceiver and is used to transmit and receive signals (e.g., messages or packets) according to processing results of the processor 800. In an embodiment, the communication unit 820 transmits and receives the signals via at least one antenna 822 shown in FIG. 8.

In an embodiment, the storage unit 810 and the program code 812 may be omitted and the processor 800 may include a storage unit with stored program code.

The processor 800 may implement any one of the steps in exemplified embodiments on the wireless terminal 80, e.g., by executing the program code 812.

The communication unit 820 may be a transceiver. The communication unit 820 may as an alternative or in addition be combining a transmitting unit and a receiving unit configured to transmit and to receive, respectively, signals to and from a wireless network node (e.g., a base station).

FIG. 9 relates to a schematic diagram of a wireless network node 90 according to an embodiment of the present disclosure. The wireless network node 90 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 90 may comprise (perform) at least one network function such as an access and mobility management function (AMF), a session management function (SMF), a user place function (UPF), a policy control function (PCF), an application function (AF), etc. The wireless network node 90 may include a processor 900 such as a microprocessor or ASIC, a storage unit 910 and a communication unit 920. The storage unit 910 may be any data storage device that stores a program code 912, which is accessed and executed by the processor 900. Examples of the storage unit 912 include but are not limited to a SIM, ROM, flash memory, RAM, hard-disk, and optical data storage device. The communication unit 920 may be a transceiver and is used to transmit and receive signals (e.g., messages or packets) according to processing results of the processor 900. In an example, the communication unit 920 transmits and receives the signals via at least one antenna 922 shown in FIG. 9.

In an embodiment, the storage unit 910 and the program code 912 may be omitted. The processor 900 may include a storage unit with stored program code.

The processor 900 may implement any steps described in exemplified embodiments on the wireless network node 90, e.g., via executing the program code 912.

The communication unit 920 may be a transceiver. The communication unit 920 may as an alternative or in addition be combining a transmitting unit and a receiving unit configured to transmit and to receive, respectively, signals to and from a wireless terminal (e.g., a user equipment or another wireless network node).

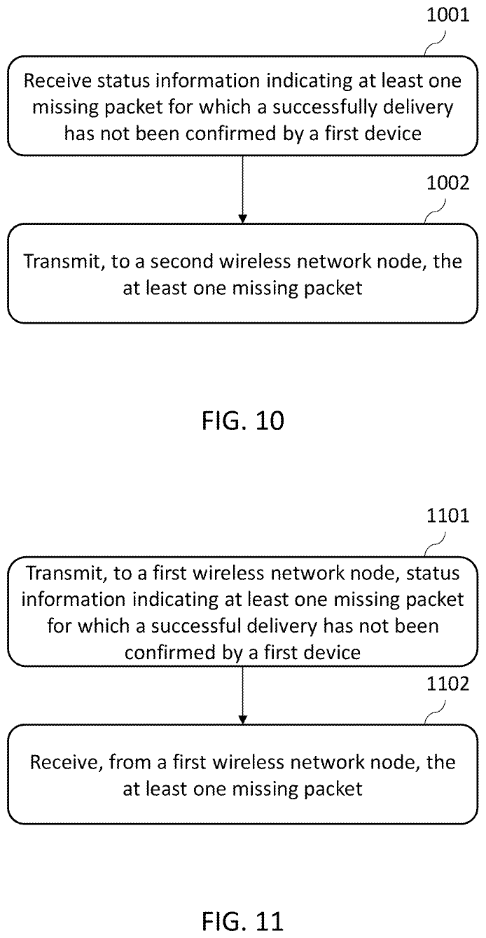

FIG. 10 shows a flowchart of a method according to an embodiment of the present disclosure. The method shown in FIG. 10 may be used in a first wireless network node (e.g., source gNB or gNB1 shown in FIGS. 3 to 7) and comprises the following steps:
Step 1001: Receive status information indicating at least one missing packet for which a successfully delivery has not been confirmed by a first device.
Step 1002: Transmit, to a second wireless network node, the at least one missing packet.

In this embodiment, the first device (e.g., remote UE) connected to the first wireless network via a second device (e.g., relay UE). The first wireless network node receives status information (e.g., PDCP status) of the first device, wherein the status information indicates at least one missing packet for which a successfully delivery has not been confirmed by the first device. Based on the status information, the first wireless network node transmits the at least one missing packet to a second wireless network node (e.g., target gNB). For example, the second wireless network node may be the BS or RAN node serving the first device (e.g., through a relay device).

In an embodiment, the packet may be equal to a data unit (e.g., PDU or SDU).

In an embodiment, the first wireless network node receives the status information from the second wireless network node. In this embodiment, the status information comprises a PDCP status report of the first device for DL packets. As an alternative or in addition, the status information comprises at least one of a field indicating the first missing packet (e.g., First missing COUNT) or a bitmap for downlink packets, wherein the bitmap indicates the at least one missing packet and/or at least one packet for which a successful delivery has been confirmed the first device.

In an embodiment, the first wireless network node receives the status information from the second device. In this embodiment, the status information comprises at least one RLC status of at least one DL packet received by the first device. For example, the RLC status may be one of acknowledge status and non-acknowledge status. As an alternative, the status information comprises at least one of at least one PDCP SN of the at least one missing packet or at least one PDCP SN of at least one packet for which a successful delivery has been confirmed by the first device.

In an embodiment, the first wireless network node may perform a path switch of handing over the first device to the second wireless network node or to a third device (e.g., another relay device) served by the second wireless network node.

In an embodiment, the first device performs an RRC reestablishment with the second wireless network node.

FIG. 11 shows a flowchart of a method according to an embodiment of the present disclosure. The method shown in FIG. 11 may be used in a second wireless network node (e.g., a target gNB or gNB2 shown in FIGS. 3 to 6) and comprises the following steps:
Step 1101: Transmit, to a first wireless network node, status information indicating at least one missing packet for which a successful delivery has not been confirmed by a first device.
Step 1102: Receive, from a first wireless network node, the at least one missing packet.

In FIG. 11, the second wireless network node transmits status information indicating at least one missing packet for which a successful delivery has not been confirmed by a first device to a first wireless network node (e.g., source gNB or gNB1 shown in FIGS. 3 to 7). In this embodiment, the first device (e.g., remote UE) connected to the first wireless network node via a second device (e.g., relay UE). For example, the first device may be handed over to the second wireless network node or the first device may be switched to a third device (e.g., relay UE) served by the second wireless network node or the first device may perform an RRC re-establishment with the second wireless network node. The second wireless network node receives the at least one missing packet from the first wireless network node. Next, the second wireless network node may transmit the received missing packet(s) to the first device.

In an embodiment, the packet may be equal to a data unit (e.g., PDU or SDU).

In an embodiment, the status information comprises a PDCP status report of the first device for DL packets. As an alternative or in addition, the status information comprises at least one of a field indicating the first missing packet (e.g., First missing COUNT) or a bitmap for downlink packets, wherein the bitmap indicates the at least one missing packet and/or at least one packet for which a successful delivery has been confirmed the first device.

In an embodiment, the second wireless network node may receive a PDCP status report for DL packets from the first device. Based on the PDCP status report, the second wireless network node determines/generates the status information.

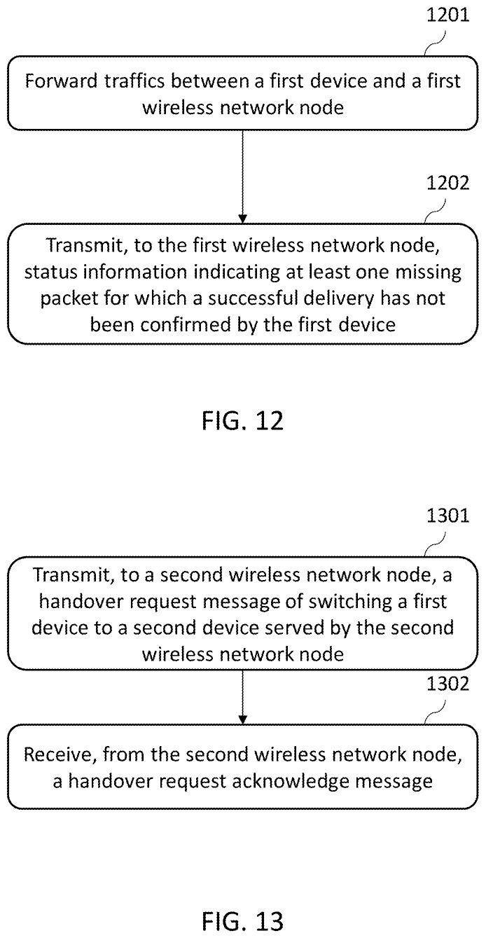

FIG. 12 shows a flowchart of a method according to an embodiment of the present disclosure. The method shown in FIG. 12 may be used in a second device (e.g., relay device) and comprises the following steps:
Step 1201: Forward traffics between a first device and a first wireless network node.
Step 1202: Transmit, to the first wireless network node, status information indicating at least one missing packet for which a successful delivery has not been confirmed by the first device.

In FIG. 12, the second device forwards traffic between a first device (e.g., remote UE) and a first wireless network node (e.g., source gNB or gNB1 shown in FIGS. 3 to 7). That is the first device connects to the first wireless network node via the second device. In this embodiment, the second device transmits status information indicating at least one missing packet for which a successful delivery has not been confirmed by the first device to the first wireless network node.

In an embodiment, the status information comprises at least one RLC status of at least one DL packet received by the first device. For example, the RLC status may be one of acknowledge status and non-acknowledge status. As an alternative, the status information comprises at least one of at least one PDCP SN of the at least one missing packet or at least one PDCP SN of at least one packet for which a successful delivery has been confirmed by the first device.

FIG. 13 shows a flowchart of a method according to an embodiment of the present disclosure. The method shown in FIG. 13 may be used in a first wireless network node (e.g., source gNB or gNB1 shown in FIGS. 3 to 7) and comprises the following steps:
Step 1301: Transmit, to a second wireless network node, a handover request message of switching a first device to a second device served by the second wireless network node.
Step 1302: Receive, from the second wireless network node, a handover request acknowledge message.

In FIG. 13, the first wireless network node transmits a handover request message of switching a first device (e.g., remote UE) to a second device (e.g., relay UE) served by the second wireless network node (e.g., target UE or gNB2 shown in FIGS. 3 to 6). In response to the handover request message, the first wireless network node receives a handover request acknowledge message from the second wireless network node.

In an embodiment, the handover request message comprises at least one of a relay path switch indication, a layer 2 identifier of the first device, an L2 identifier of the second device or a C-RNTI of the second device. For example, the relay path switch indication may refer to an indication of a path switch to a relay link (e.g., indirect link).

In an embodiment, the handover request acknowledge message comprises at least one of a C-RNTI assigned by the second wireless network node for the first device, a local ID assigned by the second wireless network node for the first device, a PC5 RLC configuration for relaying traffics or the end-to-end radio bearer configuration for the first device.

In an embodiment, the second device is selected from at least one candidate second device reported by the first device. In this embodiment, the first wireless network node may transmit at least one criterion for reporting the at least one candidate second device to the first device. For example, the at least one criterion comprises at least one of a black-list of candidate second devices, a white-list of candidate second devices, a black-list of candidate cell IDs serving candidate second devices, a white-list of candidate cell IDs serving candidate second devices, a maximum number of the candidate second devices reported by the first device or a priority for each sidelink measurement report event for reporting the candidate second device.

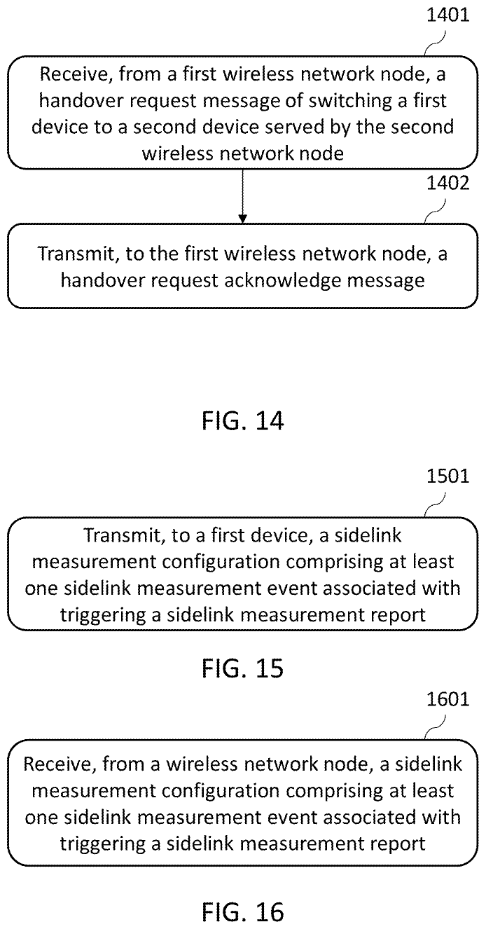

FIG. 14 shows a flowchart of a method according to an embodiment of the present disclosure. The method shown in FIG. 14 may be used in a second wireless network node (e.g., target gNB or gNB2 shown in FIGS. 3 to 6) and comprises the following steps:
Step 1401: Receive, from a first wireless network node, a handover request message of switching a first device to a second device served by the second wireless network node.
Step 1402: Transmit, to the first wireless network node, a handover request acknowledge message.

In FIG. 14, the second wireless network node receives a handover request message of switching a first device (e.g., remote UE) to a second device (e.g., relay UE) served by the second wireless network node from a first wireless network node (e.g., source gNB or gNB1 shown in FIGS. 3 to 7. In response to the handover request message, the second wireless network node transmits a handover request acknowledge message to the first wireless network node.

In an embodiment, the handover request message comprises at least one of a relay path switch indication, a layer 2 identifier of the first device, an L2 identifier of the second device or a C-RNTI of the second device. For example, the relay path switch indication may refer to an indication of a path switch to a relay link (e.g., indirect link).

In an embodiment, the handover request acknowledge message comprises at least one of a C-RNTI assigned by the second wireless network node for the first device, a local ID assigned by the second wireless network node for the first device, a PC5 RLC configuration for relaying traffics or the end-to-end radio bearer configuration for the first device.

FIG. 15 shows a flowchart of a method according to an embodiment of the present disclosure. The method shown in FIG. 15 may be used in a wireless network node (e.g., BS) and comprises the following step:
Step 1501: Transmit, to a first device, a sidelink measurement configuration comprising at least one sidelink measurement event associated with triggering a sidelink measurement report.

In FIG. 15, the wireless network node transmits/configures a sidelink measurement configuration to a first device (e.g., UE or remote UE). The sidelink measurement configuration comprises at least one sidelink measurement event associated with triggering a sidelink measurement report. In this embodiment, the first device may connect to the wireless network node via a second device (e.g., relay device).

In an embodiment, the at least one sidelink measurement event comprises at least one of:
a quality of a serving relay link between the first device and the second device is lower than a first threshold,
a quality of a candidate relay link between the first device and a candidate device is greater than a second threshold,
a quality of a serving relay link between the first device and the second device is lower than a third threshold and a quality of a candidate relay link between the first device and a candidate device is greater than a fourth threshold,
a quality of a serving relay link between the first device and the second device is lower than a quality of a candidate relay link between the first device and a candidate device, or
a quality of a serving relay link between the first device and the second device is lower than a quality of a candidate relay link between the first device and a candidate device by an offset.

In an embodiment, the quality is a sidelink reference signal received power (SL-RSRP) or a sidelink discovery reference signal received power (SD-RSRP).

FIG. 16 shows a flowchart of a method according to an embodiment of the present disclosure. The method shown in FIG. 16 may be used in a first device (e.g., UE or remote UE) and comprises the following step:
Step 1601: Receive, from a wireless network node, a sidelink measurement configuration comprising at least one sidelink measurement event associated with triggering a sidelink measurement report.

In FIG. 16, the first device receives a sidelink measurement configuration from a wireless network node (e.g., BS, gNB). The sidelink measurement configuration comprises at least one sidelink measurement event associated with triggering a sidelink measurement report. In this embodiment, the first device may connect to the wireless network node via a second device (e.g., relay device).

In an embodiment, the at least one sidelink measurement event comprises at least one of:
a quality of a serving relay link between the first device and the second device is lower than a first threshold,
a quality of a candidate relay link between the first device and a candidate device is greater than a second threshold,
a quality of a serving relay link between the first device and the second device is lower than a third threshold and a quality of a candidate relay link between the first device and a candidate device is greater than a fourth threshold,
a quality of a serving relay link between the first device and the second device is lower than a quality of a candidate relay link between the first device and a candidate device, or
a quality of a serving relay link between the first device and the second device is lower than a quality of a candidate relay link between the first device and a candidate device by an offset.

In an embodiment, the quality is a sidelink reference signal received power (SL-RSRP) or a sidelink discovery reference signal received power (SD-RSRP).

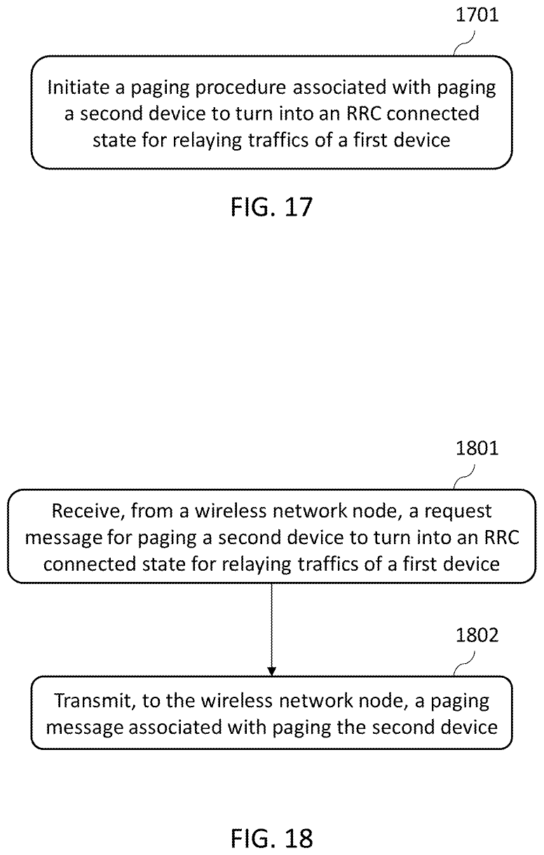

FIG. 17 shows a flowchart of a method according to an embodiment of the present disclosure. The method shown in FIG. 17 may be used in a wireless network node (e.g., BS) and comprises the following step:
Step 1701: Initiate a paging procedure associated with paging a second device to turn into an RRC connected state for relaying traffics of a first device.

In FIG. 17, a second device (e.g., relay UE) in an RRC idle/inactive state may be selected for relaying traffics between a first device (e.g., remote UE) and the wireless network node. In this embodiment, the wireless network node initiates a paging procedure associated with paging the second device to turn/enter into an RRC connected state for relaying traffics of the first device.

In an embodiment, the second device is in the RRC inactive state. In this embodiment, the paging procedure comprises transmitting, to at least one neighbor wireless network node, a paging message comprising at least one of an indication of relaying traffics or an L2 ID of the second device.

In an embodiment, the second device is in an RRC inactive state. In this embodiment, the paging procedure comprises transmitting, to the last wireless network node serving the second device, a request message for paging the second device. The request message comprises at least one of an indication of relaying traffics or an L2 ID of the second device.

In an embodiment, the second device is in the RRC idle state. In this embodiment, the paging procedure comprises transmitting, to an AMF, a request message for paging the second device. the request message comprises at least one of an indication of relaying traffics, an L2 ID of the second device or an S-TMSI of the second device.

In an embodiment, the wireless network node may receive a paging message associated with paging the second device from the AMF. The paging message comprises at least one of the L2 ID of the second device, the S-TMSI of the second device or the indication of relaying traffics.

FIG. 18 shows a flowchart of a method according to an embodiment of the present disclosure. The method shown in FIG. 18 may be used in an AMF (e.g., a wireless device comprising the AMF or a wireless device performing at least part of functionalities of the AMF) and comprises the following steps:
Step 1801: Receive, from a wireless network node, a request message for paging a second device to turn into an RRC connected state for relaying traffics of a first device.
Step 1802: Transmit, to the wireless network node, a paging message associated with paging the second device.

In FIG. 18, the AMF receives a request message for paging a second device (e.g., relay UE) to turn/enter into the RRC connected state for relaying traffics of a first device (e.g., remote UE) from a wireless network node (e.g., BS). The AMF then transmits a paging message associated with paging the second device to the wireless network node. In this embodiment, the request message comprises at least one of an indication of relaying traffics, an L2 ID of the second device or an S-TMSI of the second device.

In an embodiment, the paging message comprises at least one of the L2 ID of the second device, the S-TMSI of the second device, or the indication of relaying traffics.

Note that the aforementioned embodiments may be combined if not conflicting to each other. For example, the sidelink measurement report event(s) recited in any of embodiments shown in FIGS. 7, 15 and 16 may be transmitted to the remote UE or first device in any of embodiments shown in FIGS. 3 to 6, 10 to 14, 17 and 18. In addition, the method shown in FIG. 17 or 18 may be performed in any of embodiments shown in FIGS. 6 and 10 to 14.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in a wireless network node, the wireless communication method comprising:
transmitting, to a first device, a sidelink measurement configuration comprising at least one sidelink measurement event associated with triggering a sidelink measurement report,
wherein the first device connects to the wireless network node via a second device.

2. The wireless communication method of claim 1, wherein the at least one sidelink measurement event comprises:
a quality of a serving relay link between the first device and the second device is lower than a third threshold and a quality of a candidate relay link between the first device and a candidate device is greater than a fourth threshold.

3. The wireless communication method of claim 2, wherein the quality is a sidelink reference signal received power or a sidelink discovery reference signal received power.

4. The wireless communication method of claim 1, wherein the first device indicates whether a measurement result is a sidelink reference signal received power or a sidelink discovery reference signal received power for at least one of: a serving relay link or candidate relay links in the sidelink measurement report.

5. A wireless communication method for use in a first device, the wireless communication method comprising:
receiving, from a wireless network node, a sidelink measurement configuration comprising at least one sidelink measurement event associated with triggering a sidelink measurement report,
wherein the first device connects to the wireless network node via a second device.

6. The wireless communication method of claim 5, wherein the at least one sidelink measurement event comprises:
a quality of a serving relay link between the first device and the second device is lower than a third threshold and a quality of a candidate relay link between the first device and a candidate device is greater than a fourth threshold.

7. The wireless communication method of claim 6, wherein the quality is a sidelink reference signal received power or a sidelink discovery reference signal received power.

8. The wireless communication method of claim 5, wherein the first device indicates whether a measurement result is a sidelink reference signal received power or a sidelink discovery reference signal received power for at least one of: a serving relay link or candidate relay links in the sidelink measurement report.

9. A first device, comprising:
a communication unit, configured to receive, from a wireless network node, a sidelink measurement configuration comprising at least one sidelink measurement event associated with triggering a sidelink measurement report,
wherein the first device connects to the wireless network node via a second device.

10. The first device of claim 9, wherein the at least one sidelink measurement event comprises:
a quality of a serving relay link between the first device and the second device is lower than a third threshold and a quality of a candidate relay link between the first device and a candidate device is greater than a fourth threshold.

11. The first device of claim 10, wherein the quality is a sidelink reference signal received power or a sidelink discovery reference signal received power.

12. The first device of claim 9, wherein the first device indicates whether a measurement result is a sidelink reference signal received power or a sidelink discovery reference signal received power for at least one of: a serving relay link or candidate relay links in the sidelink measurement report.
